(19) United States
(12) Patent Application Publication
(10) Pub. No.: US 2007/0145763 A1
(43) Pub. Date: Jun. 28, 2007

(54) Vehicle gel coated panel

(76) Inventor: Anke Mazzei, Encinitas, CA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/318,891

(22) Filed: Dec. 27, 2005

(51) Int. Cl. B62D 25/14

(52) U.S. Cl. 296/70

(57) ABSTRACT

A vehicle panel having a gel covering is shown and described. The gel is a translucent and is disposed on a support member that is attached to the frame of the instrument panel. The support member defines a pattern such as a mesh pattern that is visible through the gel.

### FIELD

Vehicle instrument panels used to retain steering wheels, controls, instruments, and/or airbag systems are disclosed, and in particular, the occupant-facing skins or coverings of the instrument panel are shown and described.

### BACKGROUND

In vehicles such as automobiles, a number of surfaces or panels typically comprise the vehicle interior. These panels include the door panel, the dashboard, and the instrument panel. Instrument panels are designed to retain and/or display a variety of components, such as the steering wheel, indicators (e.g., speedometer, oil temperature gauge, and warning lights), as well as various controls (e.g., air conditioner, heater, and radio controls).

Known instrument panels are typically made from opaque thermoplastic materials, including polyvinyl chloride, mixtures of polyvinyl chloride and ABS (acrylonitrile-butadiene-styrene block copolymers) or TPO (thermoplastic olefins). The panels may comprise a single integrally molded piece, or a variety of layers, such as a PVC skin on a thermoplastic foam. Such known materials are typically opaque, giving them a limited and somewhat dull appearance. Many of the materials are also rigid and not soft to the touch. Thus, a need has arisen for a vehicle panel that addresses the foregoing issues.

### SUMMARY OF THE EMBODIMENTS

A vehicle panel comprises a gel. In certain embodiments, the vehicle panel is one selected from an instrument panel, a dashboard, and a door panel. In certain other embodiments, the gel is translucent. In further embodiments, the gel is a silicone gel. In still other embodiments, the gel has a textured surface. In even further embodiments, the gel is at least partially cross linked. In additional embodiments, the gel is non-abrasive.

An instrument panel for a vehicle comprises a frame, a support member attached to the frame, and a gel disposed on the support member. In certain embodiments, the gel is translucent. In other embodiments, the support member defines a pattern that is visible through the gel. In additional embodiments, the support member is a mesh.

A method of making a vehicle instrument panel comprises providing an instrument panel frame, attaching a support member to the frame, pouring a translucent gel into a mold, at least partially cross linking the gel, removing the at least partially cross linked gel, and disposing the at least partially cross linked gel on the support member. In certain embodiments, the support member has a mesh pattern. In certain other embodiments, the mold has a textured surface.

### BRIEF DESCRIPTION OF THE DRAWINGS

Embodiments will now be described by way of example in greater detail with reference to the attached figures, in which:

FIG. 1 shows an instrument panel comprising passenger and driver side gel coverings; and

FIG. 2 is an exploded view of the passenger-side section of the gel coated instrument panel of FIG. 1.

### DETAILED DESCRIPTION

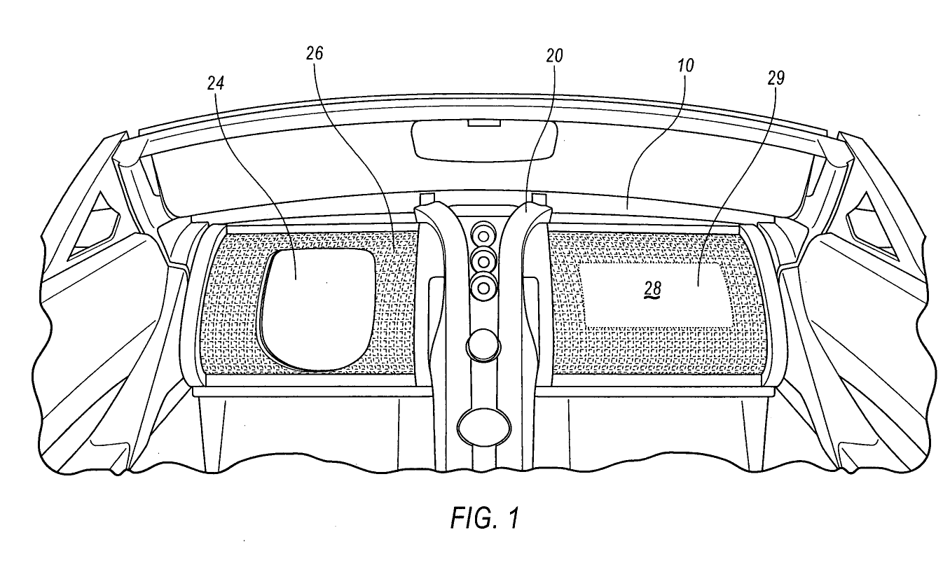

FIG. 1 shows generally at 10 an instrument panel for an automobile. As described further below, instrument panel 10 comprises a gel covering that preferably is translucent and has a relatively soft and appealing appearance. Although the translucent gel covering of FIG. 1 is depicted in the context of an automotive instrument panel, embodiments of the covering may be used for other automotive panels (e.g., doors or dashboards), other types of vehicles, or for non-vehicle applications, and their use is not limited to automotive instrument panels. For example, the embodiments described herein may be used with airplane, truck, or bus interiors as well as for non-vehicle applications.

Instrument panel 10 comprises a frame or console 20 which may be constructed of known materials such as suitably rigid plastics or metals. Frame 20 is attached to the body of the vehicle and is used to retain and support the remainder of instrument panel 10. A steering wheel and instruments (not shown) are also provided on the driver side of instrument panel 10.

Instrument panel 10 comprises a driver side panel 26 for covering a portion of the driver side of instrument panel 10 and a passenger side panel 28 for covering a portion of the passenger side of instrument panel 10. Although the two panels are separate in the embodiment of FIG. 1, they could also be constructed as a single panel spanning the driver and passenger side of the car.

Driver side panel 26 is preferably designed with an opening 24 to allow a steering wheel to project therethrough and to allow instruments to be seen by the driver. In one exemplary embodiment, instruments are attached to the steering column and sit in front of driver side panel 26. However, driver side panel 26 may optionally include openings that are sized to retain the instruments and make them visible to the vehicle occupants.

In many vehicles, a passenger side air bag system 29 is contained in the passenger side of instrument panel 10. To accommodate an air bag system, passenger side panel 28 may be configured to rupture in a predetermined area upon deployment of the airbag. It may also include perforations or other weakening structures that facilitate rupturing. In FIG. 1, passenger air bag system 29 is positioned behind passenger side panel 28 with respect to the vehicle occupant.

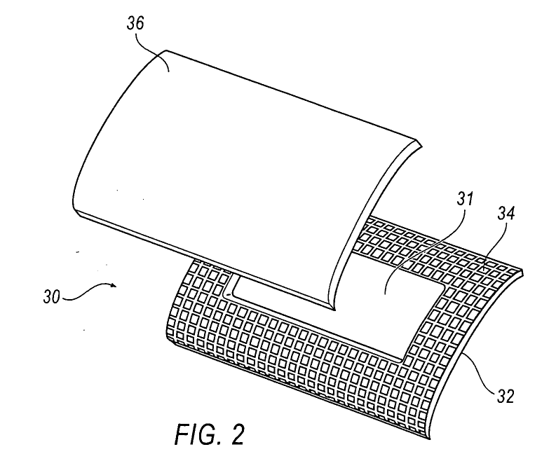

The use of gels as instrument panel coverings provides a degree of softness and an appearance that are not generally obtainable from known PVC or other thermoplastic materials. As is known in the art, gels are soft materials which are not free flowing. They are somewhat deformable, and typically lack the degree of compressive, shear and tensile stiffness found in elastomers. Referring to FIG. 2, passenger side panel 28 is preferably formed from a translucent gel section 36 which faces the vehicle occupant and allows ambient light and/or other visible light to pass through it. Driver side panel 26 is formed similarly, although its gel section is not separately shown in the figures. Although the following discussion focuses on the passenger side panel 28, it should be understood that driver side panel 26 may comprise a similar translucent gel section, even though it is not separately depicted in the figures or described herein.

The translucent gel used to form section 36 is preferably castable and can be molded to form the desired instrument panel shape. The gel is also preferably capable of being at least partially cross linked to provide the desired degree of integrity and rigidity without sacrificing the desired softness and feel.

Translucent gel section 36 may optionally be textured to enhance its feel and appearance. In one exemplary embodiment, gel section 36 has a frosted appearance, such as that of sandblasted glass, which allows light to pass without providing complete transparency. As explained further below, gel section 36 may be formed in a bead blasted or sandblasted mold to create the frosted appearance in the molding process. Alternatively, gel section 36 could be molded to include embossed patterns or logos. However, for instrument panel applications, gel section 36 is preferably formed with a non-abrasive, occupant-facing surface to reduce the likelihood of laceration to the vehicle occupants during a crash or unexpected stopping of the vehicle.

Preferred gels include translucent silicone gels such as those comprised of polydimethylsiloxanes or mixtures of the same. In one exemplary embodiment, translucent gel section 36 comprises a platinum-catalyzed polydimethylsiloxane gel distributed by Silicones, Inc. of High Point, N.C. under the trade name XP-565B. In another exemplary embodiment, translucent gel section 36 comprises a platinum-catalyzed gel comprising from about 10 to about 30 percent of a dimethylvinyl terminated polydimethylsiloxane and from about 80 to about 100 percent of a dimethyl, methylhydrogen polydimethylsiloxane distributed by Silicones, Inc. under the trade name X-565A. However, other known translucent gels such as silicone gels distributed under the TC-5000 series trade name by BJB Enterprises, Inc. of Tustin, Calif. may also be used, as may polyurethane gels.

Panels 26 and 28 may also be designed to provide energy absorbance during a crash or sudden stopping of the vehicle. In addition to the properties of the gel itself, the thickness of translucent gel section 36 (or its driver side counterpart) will affect energy absorbance. The thickness of section 36 is generally from about 0.5 to about 2.0 inches, preferably from about 0.8 to 1.5 inches, and is more preferably about 1.0 inches.

Referring to FIG. 2, a support member 30 is provided for attaching translucent gel section 36 to instrument panel frame 20. In FIG. 1, support member 30 is behind gel section 36. Although not separately depicted in the figures, driver side panel 26 includes a similar support member for attaching its corresponding translucent gel section to frame 20. In that case, support member 30 is provided with an opening for receiving steering wheel 24. It may also be include openings for retaining and displaying instruments 22.

Support member 30 is preferably strong enough to hold gel section 36 in place and retain the air bag assembly and any other electronic components within instrument panel 10. If an air bag assembly is present, support member 30 is preferably configured to include an opening 31 for deploying the airbag. Support member 30 may be attached to instrument panel frame 20 by a variety of known means, including by adhesive bonding and mechanical fastening.

In an exemplary embodiment, support member 30 has a color (yellow, for example) which reflects ambient light through translucent gel section 36. As a result, when viewed from the interior of the vehicle, instrument panels 26 and 28 display a pattern (shown in phantom in FIG. 1) that is defined by the structure of support member 30. In one embodiment, the pattern is a mesh-like grid of squares, as depicted in FIG. 2. The grid is formed from a thin plate of metal, rigid plastic or other suitable support material. Individual openings 34 are removed from the metal (e.g., by stamping) to produce the grid-like appearance. In FIG. 2, openings 34 are squares, each having sides of about ¼ in. in length. However, other patterns, including other regular or irregular geometric shapes could also be used in lieu of squares. In addition, the pattern of shapes may vary across the surface of support member 30.

Translucent gel section 36 is preferably securely retained on support member 30. In one embodiment, gel section 36 is adhesively bonded to at least a portion of support member 30. If translucent gel section 36 comprises a silicone gel, a silicone adhesive is preferably used. In addition, gel section 36 may be mechanically fastened to support member 30, including without limitation, by stitching gel section 36 to support member 30. Also, support member 30 may be molded into gel section 36.

A method for making passenger side panel 28 will now be described. Again, although the method is discussed with reference to passenger side panel 28 of the vehicle, it should be understood that the same method can be used for the driver side panel 26. In accordance with the method, a mold is provided which is formed in the desired shape of panel 28. Although any number of shapes can be used, in the embodiment of FIG. 1 panel 28 is curved when viewed from the side. However, gel section 36 may be molded as a generally flat section which is then deformed upon attachment to create the curved appearance in FIG. 1. The mold is preferably constructed from known materials and includes a textured surface, which more preferably is obtained by bead blasting or sandblasting the mold. During the molding process, the textured mold surface will produce a corresponding textured surface on translucent gel section 36. As mentioned previously, in one exemplary embodiment the textured surface is non-abrasive and has the appearance of frosted glass.

The translucent gel is poured or otherwise placed into the mold. As mentioned above, a number of known silicone gels may be used. However, the selected gel is preferably moldable and capable of being at least partially cross linked. Along with the gel composition, the degree of cross linking will affect the gel properties. As cross linking increases, the gel will tend to become harder and more rigid, losing its softness. However, an insufficient degree of cross linking may produce a gel that lacks sufficient integrity or rigidity to remain in place or to provide energy absorbance.

After pouring the gel into the mold, it is preferably cross linked, for example, by thermal curing. In one embodiment, an XP-565 silicone gel distributed by Silicones, Inc. is used and is cured at about 115° F. for about 16 hours. Chemical cross linking agents may also be in addition to or in lieu of thermal curing. Depending on the gel that is selected, UV or infrared cross linking may also be used. Following curing, gel section 36 is removed from the mold and affixed to support member 30 using one of the techniques described above. Support member 30 is then attached to frame 20 using one of the techniques described above. If the method of attachment includes molding support member 30 into gel section 36, support member 30 is preferably placed into the mold prior to cross linking.

Unlike known vehicle panels, instrument panels 26 and 28 allow the transmission of ambient light and other visible light wavelengths. As indicated above, this configuration allows the pattern defined by support member 30 to be viewed through panel 28. The translucent nature of the gel sections used in the foregoing embodiments can also be beneficially used in other ways. For example, lights may be incorporated on or behind support structure 30 to backlight the gel sections. Also, the gel sections maybe edge lit.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A vehicle panel comprising a gel.

2. The vehicle panel of claim 1, wherein the vehicle panel is one selected from an instrument panel, a dashboard, and a door panel.

3. The vehicle panel of claim 1, wherein the gel is translucent.

4. The vehicle panel of claim 1, wherein the gel is a silicone gel.

5. The vehicle panel of claim 1, wherein the gel is prepared by molding.

6. The vehicle panel of claim 1, wherein the gel has a textured surface.

7. The vehicle panel of claim 1, wherein the gel is at least partially cross linked.

8. The vehicle panel of claim 1, wherein the gel is non-abrasive.

9. An instrument panel for a vehicle, comprising:
a frame;
a support member attached to the frame; and
a gel disposed on the support member.

10. The instrument panel of claim 9, wherein the gel is translucent.

11. The instrument panel of claim 9, wherein the support member defines a pattern that is visible through the gel.

12. The instrument panel of claim 9, wherein the support member is a mesh.

13. The instrument panel of claim 12, wherein the mesh comprises a metal plate having a plurality of openings.

14. The instrument panel of claim 9, wherein the gel is at least partially cross linked.

15. The instrument panel of claim 9, wherein the gel is prepared by molding.

16. The instrument panel of claim 9, wherein the gel is prepared by molding in a mold having a textured surface.

17. The instrument panel of claim 9, wherein the gel is non-abrasive.

18. A method of making a vehicle instrument panel, comprising:
providing an instrument panel frame;
attaching a support member to the frame;
pouring a translucent gel into a mold;
at least partially cross linking the gel;
removing the at least partially cross linked gel from the mold; and
disposing the at least partially cross linked gel on the support member.

19. The method of claim 18, wherein the support member has a mesh pattern.

20. The method of claim 18, wherein the mold has a textured surface.
